(19) United States
(12) Patent Application Publication
(10) Pub. No.: US 2022/0011611 A1
(43) Pub. Date: Jan. 13, 2022

(54) DISPLAY PANEL AND DISPLAY DEVICE

(71) Applicant: HUIZHOU CHINA STAR OPTOELECTRONICS TECHNOLOGY CO., LTD., Huizhou, Guangdong (CN)

(72) Inventors: Dongchen HUANG, Huizhou, Guangdong (CN); Chingyuan CHENG, Huizhou,Guangdong (CN)

(21) Appl. No.: 16/981,500

(22) PCT Filed: Jul. 9, 2020
(86) PCT No.: PCT/CN2020/101097

§ 371 Date: Sep. 16, 2020

(51) Int. Cl. G02F 1/1339; G02F 1/1333; G02F 1/1335; G02F 1/13357

(52) U.S. Cl. CPC G02F 1/1339; G02F 1/13338; G02F 1/133617; G02F 1/133504; G02F 1/133531

(57) ABSTRACT

The present application discloses a display panel and a display device. The display panel includes a display module and an encapsulation cover plate disposed on a light-emitting side of the display module. The light-emitting side of the display module is further provided with a light conversion layer configured to emit indicating light when receiving specific light. The light conversion layer includes a light conversion material. The indicating light is visible light, and a brightness of the indicating light is greater than a determined brightness.

### FIELD OF INVENTION

The present application is related to the field of display technology, and specifically, to a display panel and a display device.

### BACKGROUND OF INVENTION

Large-size display panels are widely used in commercial displays, such as conference all-in-one machines and electronic whiteboards, and have a broad market demand. In teaching, lectures, and other occasions, when a display panel is used to display related presentations, beam emitters such as laser pointers are used to indicate the presentation on the display panel to enhance a presentation effect.

However, a brightness of an image displayed on the display panel is high, and reflectivity of a polarizer attached to a display region is low. When a laser pointer is used to indicate the display region of the display panel, a brightness of a light spot formed on the display panel by a light beam emitted by the laser pointer is relatively low, which makes it difficult for viewers to see the light spot on the display panel.

In current organic light-emitting diode (OLED) display panels, grooves need to be formed by multiple photomasks, and an overall process flow is relatively long, and costs are relatively high.

### SUMMARY OF INVENTION

In a first aspect, the present application provides a display panel. the display panel includes:

a display module; and

an encapsulation cover plate disposed on a light-emitting side of the display module.

The light-emitting side of the display module is further provided with a light conversion layer configured to emit indicating light when receiving specific light. The light conversion layer includes a light conversion material. The indicating light is visible light, and a brightness of the indicating light is greater than a determined brightness.

In an embodiment, the display module includes a display screen body and a touch layer disposed on a side of the display screen body near the encapsulation cover plate. A first sealant is provided between the encapsulation cover plate and the touch layer. The first sealant, the encapsulation cover plate, and the touch layer form a cavity.

In an embodiment, the encapsulation cover plate includes a cover plate body and a first polarizer disposed on a side of the cover plate body near the display module.

In an embodiment, the light conversion material is distributed on the first polarizer and/or the cover plate body to form the light conversion layer.

In an embodiment, the light conversion material is distributed in the touch layer to form the light conversion layer.

In an embodiment, the display module further includes: a second polarizer disposed between the display screen body and the touch layer and including a shielding material for the specific light; and a third polarizer disposed on a side of the display screen body away from the encapsulation cover plate.

In an embodiment, a transmittance of the first polarizer for the specific light is greater than a transmittance of the second polarizer for the specific light.

In an embodiment, the light conversion material includes a fluorescent material or an up-conversion luminescent material.

In an embodiment, the encapsulation cover plate is provided with a plurality of scattering protrusions. The plurality of scattering protrusions are provided on a side of the light conversion layer away from the display module.

In a second aspect, the application further provides a display device. The display device includes the above display panel and a beam emitter configured to emit specific light. The display panel includes:

a display module; and

an encapsulation cover plate disposed on a light-emitting side of the display module.

The light-emitting side of the display module is further provided with a light conversion layer configured to emit indicating light when receiving specific light. The light conversion layer includes a light conversion material. The indicating light is visible light, and a brightness of the indicating light is greater than a determined brightness.

In an embodiment, the display module includes a display screen body and a touch layer disposed on a side of the display screen body near the encapsulation cover plate. A first sealant is provided between the encapsulation cover plate and the touch layer. The first sealant, the encapsulation cover plate, and the touch layer form a cavity.

In an embodiment, the encapsulation cover plate includes a cover plate body and a first polarizer disposed on a side of the cover plate body near the display module.

In an embodiment, the light conversion material is distributed on the first polarizer and/or the cover plate body to form the light conversion layer.

In an embodiment, the light conversion material is distributed in the touch layer to form the light conversion layer.

In an embodiment, the display module further includes: a second polarizer disposed between the display screen body and the touch layer and including a shielding material for the specific light; and a third polarizer disposed on a side of the display screen body away from the encapsulation cover plate.

In an embodiment, a transmittance of the first polarizer for the specific light is greater than a transmittance of the second polarizer for the specific light.

In an embodiment, the light conversion material includes a fluorescent material or an up-conversion luminescent material.

In an embodiment, the encapsulation cover plate is provided with a plurality of scattering protrusions. The plurality of scattering protrusions are provided on a side of the light conversion layer away from the display module.

In an embodiment, an orthographic projection of the display module on the encapsulation cover plate is positioned in the encapsulation cover plate.

In an embodiment, the second polarizer is a wide-viewing-angle polarizer.

When the display panel is used to display related presentations, a presenter uses a beam emitter to project the specific light onto the display panel, and a region on the light conversion layer corresponding to a projection position of the specific light absorbs the specific light and emits the indicating light. The indicating light emitted by the light conversion layer is the visible light with a high brightness and does not need to enter human eyes through reflection, so it is easier to be seen by the human eyes. The specific light is projected to a region with a higher display brightness on the display panel, and viewers can also clearly see a light spot formed by the indicating light on the display panel. Therefore, in scenes such as conferences and teaching, the presenter can use the beam emitter to realize a function of pointer instruction on the display panel.

### DESCRIPTION OF DRAWINGS

The following describes specific embodiments of the present application in detail with reference to the accompanying drawings, which will make technical solutions and other beneficial effects of the present application obvious.

FIG. 1 is a first structural schematic diagram of a display panel in an embodiment of this application.

FIG. 2 is a structural schematic diagram of a first polarizer in an embodiment of this application.

FIG. 3 is a second structural schematic diagram of the display panel in an embodiment of this application.

FIG. 4 is a third structural schematic diagram of the display panel in an embodiment of this application.

FIG. 5 is a fourth structural schematic diagram of the display panel in an embodiment of this application.

FIG. 6 is a structural schematic diagram of a display device in an embodiment of this application.

### REFERENCE SIGNS

display panel 10, display module 11, display screen body 111, array substrate 111a, color filter substrate 111b, second sealant 111c, liquid crystal layer 111d, second polarizer 112, third polarizer 113, touch layer 114, encapsulation cover plate 12, cover plate body 121, first polarizer 122, pressure-sensitive adhesive layer 122a, first waterproof layer 122b, polarizing layer 122c, second waterproof layer 122d, protective layer 122e, light conversion layer 13, light conversion material 131, first sealant 14, cavity 15, scattering protrusions 16, backlight module 17, beam emitter 20.

### DETAILED DESCRIPTION OF PREFERRED EMBODIMENTS

Examples are described below with reference to the appended drawings, and the drawings illustrate particular embodiments in which the present application may be practiced. Directional terms mentioned in the present application, such as upper, lower, front, rear, left, right, in, out, side, etc., only refer to directions in the accompanying drawings. Thus, the adoption of directional terms is used to describe and understand the present application, but not to limit the present application. In the drawings, units of similar structures are using the same numeral to represent.

The present application addresses technical problems in current display panels that a brightness of an image displayed on the display panel is high, and reflectivity of a polarizer attached to the display region is low. When a laser pointer is used to indicate a display region of the display panel, a brightness of a light spot formed on the display panel by a light beam emitted by the laser pointer is relatively low, which makes it difficult for viewers to see the light spot on the display panel.

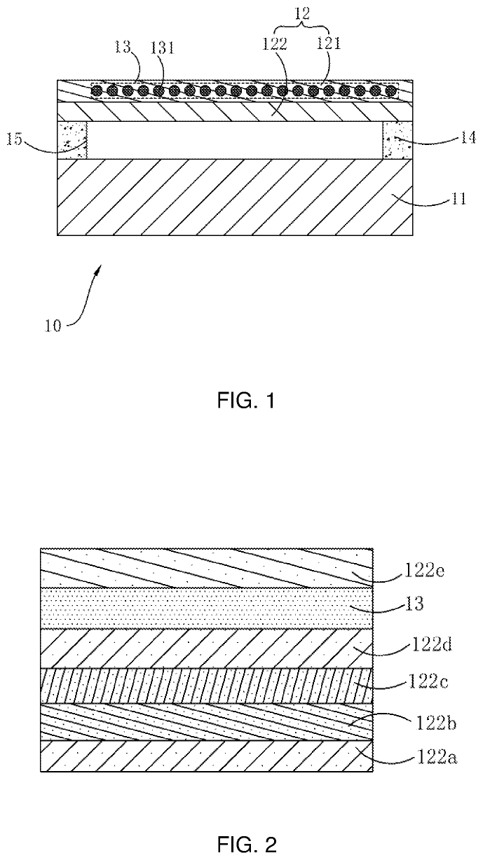

As shown in FIG. 1, a display panel 10 includes a display module 11 and an encapsulation cover plate 12 disposed on a light-emitting side of the display module 11.

Specifically, the display module 11 can be liquid crystal display module. The encapsulation cover plate 12 is a transparent cover plate. The encapsulation cover plate 12 can be a transparent plastic cover plate or a transparent glass cover plate. An orthographic projection of the display module 11 on the encapsulation cover plate 12 is positioned in the encapsulation cover plate 12, that is, a size of the encapsulation cover plate 12 is larger than a size of the display module 11. The encapsulation cover plate 12 is configured to prevent the display module 11 from being directly squeezed, collided, and contacted with water vapor.

Specifically, a first sealant 14 is provided between the encapsulation cover plate 12 and the display module 11. The first sealant 14 is bonded to the encapsulation cover plate 12 and the display module 11. The first sealant 14, the encapsulation cover plate 12, and the display module 11 form a cavity 15.

It should be explained that the encapsulation cover plate 12 is attached to the display module 11 through the first sealant 14. The first sealant 14 can be an ultraviolet curing adhesive. One of the encapsulation cover plate 12 or the display module 11 is coated with a sealant material, and the sealant material is cured by ultraviolet light to form the first sealant 14 after the encapsulation cover plate 12 is attached to the display module 11.

Specifically, the first sealant 14 is disposed at an edge region of the display module 11 and surrounds a light-emitting region of the display module 11. The cavity 15 can be filled with air to prevent the encapsulation cover plate 12 from being depressed toward the cavity 15 under action of atmospheric pressure. In an actual implementation, the cavity 15 can also be a vacuum cavity 15.

It should be explained that compared with a method that the encapsulation cover plate 12 is attached to the display module 11 by an entire surface of an optical adhesive layer, the encapsulation cover plate 12 is attached to the display module 11 through the first sealant 14, so the present process is simple, and a yield is high. Meanwhile, there is no optical adhesive layer in the cavity 15, which can increase a light transmittance of the display panel 10.

In an embodiment, the encapsulation cover plate 12 includes a cover plate body 121 and a first polarizer 122 disposed on a side of the cover plate body 121 near the display module 11.

It should be explained that the first polarizer 122 is a linear polarizer, and ambient light is generally similar to circularly polarized light. When the ambient light passes through the first polarizer 122, nearly half of the ambient light cannot pass through the first polarizer 122, and only part of the ambient light passes through the first polarizer 122 and then is reflected multiple times in the cavity 15 between the cover plate body 121 and the display module 11. An amount and intensity of the ambient light reflected between the cover plate body 121 and the display module 11 is relatively small. Even if users view the display panel 10 at viewing angles of specular reflection (such as wide viewing angles), a whitening phenomenon will not be seen, thereby increasing visibility of the wide viewing angles and improving user experiences.

Specifically, the light-emitting side of the display module 11 is further provided with a light conversion layer 13 configured to emit indicating light when receiving specific light. The light conversion layer 13 includes a light conversion material 131. The indicating light is visible light, and a brightness of the indicating light is greater than a determined brightness.

It should be explained that when the display panel 10 is used to display related presentations, a presenter uses a beam emitter 20 to project the specific light onto the display panel 10, and a region on the light conversion layer 13 corresponding to a projection position of the specific light absorbs the specific light and emits the indicating light, thereby realizing a function of actively emitting light of the light conversion layer 13. The indicating light emitted by the light conversion layer 13 is the visible light with a high brightness and does not need to enter human eyes through reflection, so it is easier to be seen by the human eyes. The specific light is projected to a region with a higher display brightness on the display panel 10, and viewers can also clearly see a light spot formed by the indicating light on the display panel 10. Therefore, in scenes such as conferences and teaching, the presenter can use the beam emitter 20 to realize a function of pointer instruction on the display panel 10.

It should be explained that a brightness value of the indicating light can be selected according to actual conditions. The brightness value of the indicating light can be greater than a display brightness value of the display panel 10. The indicating light can be red light or green light which is more easily perceivable by the human eyes, so that the light spot formed by the indicating light on the display panel 10 can be more easily seen by the viewers.

Specifically, the light conversion material 131 includes a fluorescent material or an up-conversion luminescent material.

If the light conversion material 131 includes the fluorescent material, the fluorescent material can absorb light with a certain wavelength and immediately emit visible light with different wavelengths, such as red light, green light, orange light, and yellow light. When the light irradiated on the fluorescent material disappears, the fluorescent material immediately stops emitting light. The fluorescent material can be a complex of rare-earth element europium and an organic ligand, a complex of a rare-earth element terbium and an organic ligand, or a heterocyclic compound, such as oxazine or oxazole compound.

If the light conversion material 131 includes the up-conversion luminescent material, the up-conversion luminescent material can be excited by low-energy light and emit high-energy light. If the up-conversion luminescent material is excited by low-energy invisible light, it emits high-energy visible light. The up-conversion luminescent material includes a main material and a sensitizer. The sensitizer is used to absorb the light irradiated on the up-conversion luminescent material and transfer the absorbed light to the main material, so that the main material is excited by the light.

It should be explained that if the up-conversion luminescent material is an up-conversion red light material, the up-conversion luminescent material emits red light after being excited by the specific light. At this time, the main material can be yttrium barium fluoride crystal, the sensitizer can be titanium-ion or ytterbium-ion, etc. The indicating light can be infrared light with a wavelength of about 960 nanometers. If the up-conversion luminescent material is an up-conversion green light material, the up-conversion luminescent material emits green light after being excited by the specific light. At this time, the main material can be tungsten-aluminum-oxide, the sensitizer can be erbium-ion, and the indicating light can be infrared light with a wavelength of about 960 nanometers.

In an embodiment, the light conversion material 131 is distributed on the first polarizer 122 and/or the cover plate body 121 to form the light conversion layer 13.

It should be explained that the light conversion material 131 can be uniformly distributed on the first polarizer 122 and/or the cover plate body 121, and FIG. 1 only illustrates a distribution of the light conversion material 131 on the cover plate body 121. In an actual implementation, the light conversion material 131 can be distributed only on the first polarizer 122 to form the light conversion layer 13, and the light conversion material 131 can also be distributed on the first polarizer 122 and the cover plate body 121 at a same time to form the light conversion layer 13 on both the first polarizer 122 and the cover plate body 121.

As shown in FIG. 2, if the light conversion material 131 is distributed in the first polarizer 122 to form the light conversion layer 13, the first polarizer 122 can include a first waterproof layer 122b, a polarizing layer 122c disposed on the first waterproof layer 122b, and a second waterproof layer 122d disposed on a side of the polarizing layer 122c away from the first waterproof layer 122b.

The light conversion layer 13 can be disposed on a side of the second waterproof layer 122d away from the polarizing layer 122c.

The first polarizer 122 can further include a protective layer 122e covering the light conversion layer 13 and a pressure-sensitive adhesive layer 122a disposed on a side of the first waterproof layer 122b away from the polarizing layer 122c. The first polarizer 122 can be attached to the cover plate body 121 through the pressure-sensitive adhesive layer 122a.

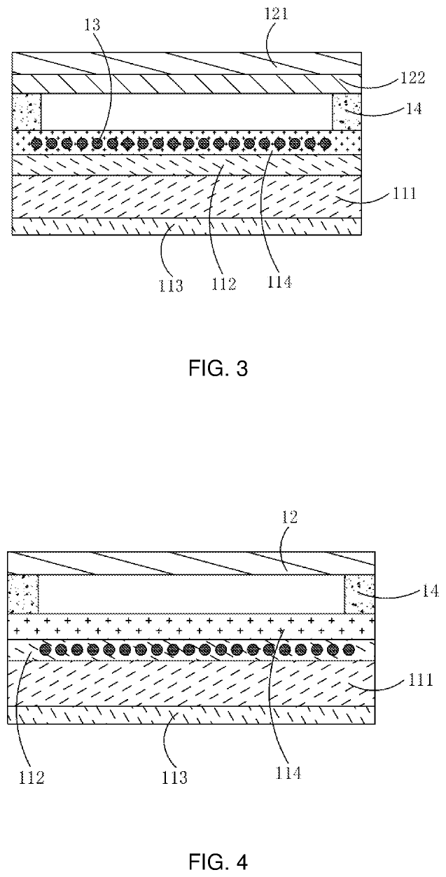

As shown in FIG. 3, the display module 11 includes a display screen body 111 and a touch layer 114 disposed between the display screen body 111 and the encapsulation cover plate 12, so that the display panel 10 has a touch function, and in scenes such as meeting and teaching, the presenter can better interact with the viewers in the meeting.

The first sealant 14, the encapsulation cover plate 12, and the touch layer 114 form the cavity 15.

In an embodiment, the light conversion material 131 is distributed in the touch layer 114 to form the light conversion layer 13.

Specifically, FIG. 3 only illustrates a case that the light conversion material 131 is only distributed in the touch layer 114. In an actual implementation, the light conversion material 131 can also be uniformly distributed in the touch layer 114 and the encapsulation cover plate 12 at a same time to form at least two layers of the light conversion layer 13.

It should be explained that the encapsulation cover plate 12 disposed on the light-emitting side of the display panel 10 generally has high transmittance and low reflectance. By disposing multiple layers of the light conversion layers 13, part of the specific light passes through a first layer of the light conversion layer 13 and is absorbed by a second layer of the light conversion layer 13. The multiple layers of the light conversion layer 13 simultaneously emit the indicating light, so that the brightness of the light spot formed by the indicating light on the display panel 10 can be more easily seen by the viewers.

Specifically, the display module 11 further includes a second polarizer 112 disposed between the display screen body 111 and the touch layer 114 and a third polarizer 113 disposed on a side of the display screen body 111 away from the encapsulation cover plate 12.

It should be explained that the third polarizer 113 is configured to convert a light beam generated by a backlight source of the display panel 10 into polarized light, and the second polarizer 112 is configured to analyze the polarized light that is electrically modulated by liquid crystal to generate a contrast between light and dark, thereby generating a display image. A polarization direction of the second polarizer 112 is parallel to a polarization direction of the first polarizer 122, so as to prevent the first polarizer 122 from affecting a normal display of the display panel 10. The polarization direction of the second polarizer 112 can be parallel or orthogonal to a polarization direction of the third polarizer 113.

In an embodiment, the second polarizer 112 includes a shielding material for the specific light.

It should be explained that by disposing the shielding material for the specific light on the second polarizer 112, when exit light emitted by the display screen body 111 passes through the second polarizer 112, a same part of the exit light as the specific light is shielded by the second polarizer 112. In this way, the exit light emitted from the display screen body 111 is prevented from causing the light conversion layer 13 to emit indicating light, and the viewers are prevented from being unable to accurately identify a specific position of the specific light emitted by the beam emitter on the display panel 10.

It should be explained that the specific light can be invisible light with low energy, so as to prevent the specific light from being repeatedly reflected in the cavity 15 between the encapsulation cover plate 12 and the display module 11 and causing whitening. Meanwhile, the low-energy invisible light causes less damage to polarizers, the liquid crystal, and semiconductor devices inside the display panel 10. The specific light can be ultraviolet light, and the shielding material for the specific light is an ultraviolet light shielding material. The specific light can also be infrared light, and the shielding material for the specific light is an infrared light shielding material.

Specifically, a transmittance of the first polarizer 122 for the specific light is greater than a transmittance of the second polarizer 112 for the specific light.

It should be explained that the brightness of the indicating light emitted by the light conversion layer 13 is related to an intensity of the specific light irradiated on the light conversion layer 13. The intensity of the specific light irradiated to the light conversion layer 13 is increased by increasing the transmittance of the first polarizer 122 for the specific light.

It should be explained that the first polarizer 122 can exclude the shielding material for the specific light, so that the transmittance of the specific light on the first polarizer 122 is higher.

In an embodiment, the second polarizer 112 is a wide-viewing-angle polarizer to increase the brightness and viewing angles of the display panel 10, so that in the meeting scene or the teaching scene, and the display panel 10 has better large-view visibility to realize meeting interaction.

As shown in FIG. 4, the light conversion material 131 is distributed on the second polarizer 112 to form the light conversion layer 13.

It should be explained that when the light conversion material 131 is distributed in at least one of the cover plate body 121, the touch layer 114, or the second polarizer 112, the first polarizer 122 can be excluded to reduce an overall thickness of the display panel 10.

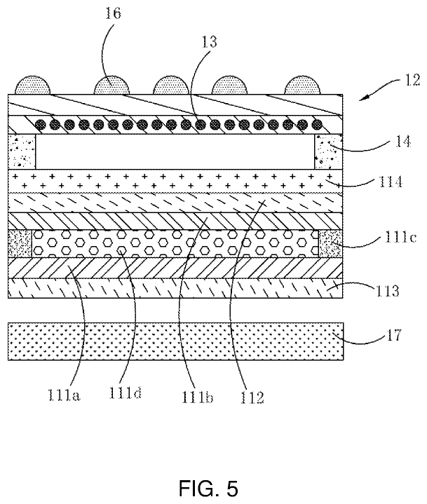

As shown in FIG. 5, the encapsulation cover plate 12 is provided with a plurality of scattering protrusions 16. The scattering protrusions 16 are provided on a side of the light conversion layer 13 away from the display module 11.

It should be explained that the scattering protrusions 16 can be configured to scatter the indicating light, so as to increase a size of the light spot formed by the indicating light on the display panel 10, and the viewers can observe a position of the light spot.

It should be explained that the scattering protrusions 16 can be integrally formed with the encapsulation cover plate 12, or can be formed on the encapsulation cover plate 12 by using a material different from the encapsulation cover plate 12. The scattering protrusions 16 can be scatteringly distributed or evenly distributed. A shape of a vertical cross-section of the scattering protrusion 16 can be semicircular, small semicircular, large semicircular, triangular, semi-elliptical, rectangular, etc., which are not listed herein. Shapes of all the scattering protrusions 16 can be same or different, and sizes of all the scattering protrusions 16 can be same or different.

Specifically, the display screen body 111 includes an array substrate 111a and a color filter substrate 111b, which are disposed oppositely. A second sealant 111c is provided between the array substrate 111a and the color filter substrate 111b. The array substrate 111a and the color filter substrate 111b form a containing cavity, and a liquid crystal layer 111d is disposed in the containing cavity.

The touch layer 114 is disposed on a side of the color filter substrate 111b away from the array substrate 111a. The third polarizer 113 is disposed on a side of the array substrate 111a away from the color filter substrate 111b.

Specifically, material of the first sealant 14 can be same as or different from material of the second sealant 111c. An orthographic projection of the first sealant 14 on the second sealant 111c is positioned in the second sealant 111c to prevent the second sealant 111c from affecting a normal display of the liquid crystal display panel 10.

Specifically, the display panel 10 also includes a backlight module 17 disposed on a side of the display module 11 away from the encapsulation cover plate 12. The backlight module 17 provides a light source for the display module 11.

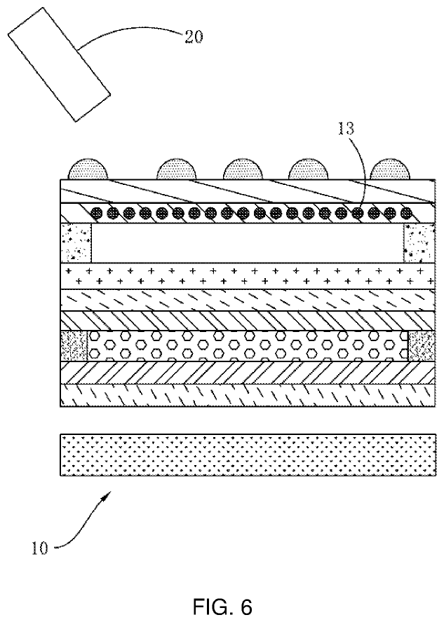

Based on the above display panel 10, the present application also provides a display device. As shown in FIG. 6, the display device includes the beam emitter 20 and the display panel 10 as described in any of the above embodiments.

The beam emitter 20 can be a laser pointer. The beam emitter 20 is configured to emit the specific light, and the light conversion layer 13 on the display panel 10 emits indicating light when the designated light is received.

Beneficial effects of the present application are as follows. When the display panel 10 is used to display related presentations, a presenter uses the beam emitter 20 to project the specific light onto the display panel 10, and a region on the light conversion layer 13 corresponding to a projection position of the specific light absorbs the specific light and emits the indicating light. The indicating light emitted by the light conversion layer 13 is the visible light with a high brightness and does not need to enter human eyes through reflection, so it is easier to be seen by the human eyes. The specific light is projected to a region with a higher display brightness on the display panel 10, and viewers can also clearly see a light spot formed by the indicating light on the display panel 10. Therefore, in scenes such as conferences and teaching, the presenter can use the beam emitter 20 to realize a function of pointer instruction on the display panel 10.

In the above embodiments, the descriptions of the various embodiments are different in emphases, for contents not described in detail, please refer to related description of other embodiments.

The description of embodiments above is only for helping to understand technical solutions of the present application and its core idea. Understandably, for a person of ordinary skill in the art can make various modifications of the technical solutions of the embodiments of the present application above. However, it does not depart from the scope of the technical solutions of the embodiments of the present application.

What is claimed is:

1. A display panel, comprising:
a display module; and
an encapsulation cover plate disposed on a light-emitting side of the display module;
wherein the light-emitting side of the display module is further provided with a light conversion layer configured to emit indicating light when receiving specific light, and the light conversion layer comprises a light conversion material; and
wherein the indicating light is visible light, and a brightness of the indicating light is greater than a determined brightness.

2. The display panel according to claim 1, wherein the display module comprises a display screen body and a touch layer disposed on a side of the display screen body near the encapsulation cover plate; and
a first sealant is provided between the encapsulation cover plate and the touch layer, and the first sealant, the encapsulation cover plate, and the touch layer form a cavity.

3. The display panel according to claim 2, wherein the encapsulation cover plate comprises a cover plate body and a first polarizer disposed on a side of the cover plate body near the display module.

4. The display panel according to claim 3, wherein the light conversion material is distributed on the first polarizer and/or the cover plate body to form the light conversion layer.

5. The display panel according to claim 3, wherein the light conversion material is distributed in the touch layer to form the light conversion layer.

6. The display panel according to claim 5, wherein the display module further comprises:
a second polarizer disposed between the display screen body and the touch layer and comprising a shielding material for the specific light; and
a third polarizer disposed on a side of the display screen body away from the encapsulation cover plate.

7. The display panel according to claim 6, wherein a transmittance of the first polarizer for the specific light is greater than a transmittance of the second polarizer for the specific light.

8. The display panel according to claim 1, wherein the light conversion material comprises a fluorescent material or an up-conversion luminescent material.

9. The display panel according to claim 1, wherein the encapsulation cover plate is provided with a plurality of scattering protrusions, and the plurality of scattering protrusions are provided on a side of the light conversion layer away from the display module.

10. A display device, comprising a display panel and a beam emitter configured to emit specific light;
wherein the display panel comprises:
a display module; and
an encapsulation cover plate disposed on a light-emitting side of the display module;
wherein the light-emitting side of the display module is further provided with a light conversion layer configured to emit indicating light when receiving specific light, and the light conversion layer comprises a light conversion material; and
wherein the indicating light is visible light, and a brightness of the indicating light is greater than a determined brightness.

11. The display device according to claim 10, wherein the display module comprises a display screen body and a touch layer disposed on a side of the display screen body near the encapsulation cover plate; and
a first sealant is provided between the encapsulation cover plate and the touch layer, and the first sealant, the encapsulation cover plate, and the touch layer form a cavity.

12. The display device according to claim 11, wherein the encapsulation cover plate comprises a cover plate body and a first polarizer disposed on a side of the cover plate body near the display module.

13. The display device according to claim 12, wherein the light conversion material is distributed on the first polarizer and/or the cover plate body to form the light conversion layer.

14. The display device according to claim 12, wherein the light conversion material is distributed in the touch layer to form the light conversion layer.

15. The display device according to claim 14, wherein the display module further comprises:
a second polarizer disposed between the display screen body and the touch layer and comprising a shielding material for the specific light; and
a third polarizer disposed on a side of the display screen body away from the encapsulation cover plate.

16. The display device according to claim 15, wherein a transmittance of the first polarizer for the specific light is greater than a transmittance of the second polarizer for the specific light.

17. The display device according to claim 15, wherein the second polarizer is a wide-viewing-angle polarizer.

18. The display device according to claim 10, wherein the light conversion material comprises a fluorescent material or an up-conversion luminescent material.

19. The display device according to claim 10, wherein the encapsulation cover plate is provided with a plurality of scattering protrusions, and the plurality of scattering protrusions are provided on a side of the light conversion layer away from the display module.

20. The display device according to claim 10, wherein an orthographic projection of the display module on the encapsulation cover plate is positioned in the encapsulation cover plate.
